(19) United States
(12) Patent Application Publication
(10) Pub. No.: US 2023/0004933 A1
(43) Pub. Date: Jan. 5, 2023

(54) Method and system for autonomous authentication

(71) Applicant: STARSHIP TECHNOLOGIES OÜ, Tallinn (EE)

(72) Inventors: Ahti HEINLA, Tallinn (EE); Lauri VÄIN, Tallinn (EE); Vahur LAAS, Keila (EE)

(73) Assignee: STARSHIP TECHNOLOGIES OÜ, Tallinn (EE)

(21) Appl. No.: 17/780,970

(22) PCT Filed: Dec. 3, 2020
(86) PCT No.: PCT/EP2020/084515

§ 371 Date: May 28, 2022

(30) Foreign Application Priority Data
Dec. 6, 2019 (EP) 19214248.7

(51) Int. Cl. G06Q 10/08

(52) U.S. Cl. CPC G06Q 10/0836; G06Q 10/0833

(57) ABSTRACT

A method and a system for secure and convenient delivery of item is disclosed. The method comprises loading a mobile robot with an item to be delivered. An item ID is generated, based on the ID of the item a security score is associated with the item. Further, a convenience score is associated with the item based on the ID. The present invention further discloses associating at least one or a plurality of authenticating techniques with the item, preferably based on the security score and/or the convenience score. The mobile robot is further configured to sense a user terminal via an authenticating sensor and facilitate the user to access an item space once the user is verified by the associated authenticating technique/s.

### FIELD

The invention relates to a method and a system configured to autonomously authenticating a user to access an item space of a mobile robot.

### INTRODUCTION

Robotic and automated vehicles for last mile delivery or transporting items have been developed and utilized in various specialized application. A robotic delivery can be energy saving, time saving, money saving and a robot can work outside the normal working hours. When an autonomous and a semi-autonomous robot delivers or transports an item to a recipient an identification of the recipient is important for security and privacy of the transported item and also of the recipient. Once the robot has reached a recipient it is important for security purposes that the robot gives an access to the item only to its rightful owner.

With the rise in e-commerce, consumer preferences have moved to home or business delivery from the parcel lockers. Consumer want more convenient options for fast, free delivery. Most of the existing last mile parcel delivery requires a human operator. In certain situations, some interaction with a person at pickup or delivery is desired, for example, for proof of delivery, for payment on delivery (also known as “cash on delivery” or “COD”), or payment of delivery costs on pickup. The growth of business-to-consumer e-commerce, for example, online shopping, is expected to continue to increase the demand for delivery services and hence the need for capacity and efficiency in the last mile.

For example, US2004/0254802A1 describes a system for the collection and delivery of goods, particularly to and from automated delivery and collection points or locker banks, uses the customer's telephone number or email address as an identifier for each delivered item. Each customer's preferred delivery address is stored on a database and accessed by means of the identifier. When ordering goods, the customer gives his telephone number or email address to a retailer who marks this on the package as the sole means of addressing the package. The identifier may also be used by the delivery person or the customer to access the automated delivery facility. Optionally the delivery person must also enter a code identifying himself, and the customer must also enter a security PIN number when collecting his goods. Alternatively, a one-time collection code is generated for each delivery and communicated to the customer, who enters it together with his identifier when collecting the delivered item. Alternatively, the customer enters the recipient's identifier into a locker bank together with a package, and the locker bank communicates the identifier automatically to the delivery organisation to initiate collection and delivery of the package. The system offers increased convenience for customers ordering goods or services over the telephone or internet.

US2019/0102962A1 describes a delivery and collection system comprises a plurality of automated locker assemblies, each comprising a plurality of contiguous lockers which are monitored and controlled by a central computer system. Each locker has an autonomous lock unit including a processor, memory and short-range wireless transceiver which communicates with any of a plurality of mobile phones or other wireless devices. Customers of the system are granted access to the lockers by validation codes which are communicated via an enabling message from the central computer system to an app running on the customer's device. The app is configured to send an access request to the lock unit based on the enabling message, and to transmit event details downloaded from the lock unit back to the central computer system. Each enabling message may authorise the user device to perform multiple deliveries or collections or may be a one-time code.

The problems related to minimizing cost, increasing efficiency, making delivery frictionless and improving infrastructure still prevails as someone have to either walk or drive to these lockers to get the package.

Also, the security associated with every item is the same which is inconvenient and time consuming. Every item doesn't need the same level of security and passing through various security levels to get to an item is not only time consuming but also waste of resources. For example, if a customer wants to pick up passport or any other important document the security plays a significant role and the consumer will be willing to take a further step to ensure the safety. On the other hand, if it is a non-valuable item, which still needs some level of security but multiple identifications are not needed can have a simple one-time password lock. In such a scenario convivence plays an important role but without compromising the safety.

Therefore, in view of the foregoing, there is a need for a computer-implemented method, system, and device to deliver an item and/or a service to a user's door and provide the optimum level of security based on the item and/or service to be delivered.

### SUMMARY

In light of the above, it is an object of the present invention to overcome or at least alleviate the shortcomings of the prior art. More particularly, it is an object of the present invention to provide a device and a method for an improved and reliable way of delivering items to recipients or users of a delivery service. Further, it is also an object to disclose mobile robots configured to deliver and/or transport items with a security level based on the item.

Particularly, it is also the object of the present invention to provide an authorization procedure for mobile robot deliveries.

In a first embodiment a mobile robot configured to transport at least one item is disclosed. The mobile robot comprises a body. The body comprises an item space. The mobile robot comprises at least one authenticating sensor. The mobile robot also comprises a processing unit. Further, the mobile robot comprises at least one enclosing structure configured to cover the item space. Furthermore, the mobile robot comprises at least one locking component configured to lock and/or unlock the enclosing structure to the body.

The enclosing structure can be a door or a lid. The body of the robot may have a removable item space. The item space may be configured to hold more than one item. The item space may be adjusted according to the parameters of the item. The authenticating sensor may be installed to the body of the mobile robot. The locking component may be locking the enclosing structure to the item space.

The authenticating sensor may comprise a camera or an optical component configured to capture image/s of the surroundings of the robot. The camera may be a 3D camera, time-of flight camera, stereo camera, etc. The authenticating sensor may be transmitting the observed or received sensor data to the processing unit. In such embodiment the authenticating sensor may be configured to take a 3D image of a user and send it to the processing unit. This is particularly advantageous during visual recognition. In a further embodiment the authenticating sensor may be configured with a scanner. The scanner may be configured with examining the user with the use of radiation, for example, ultrasound, or magnetic resonance imaging. The scanner may also be configured to scan visual data. The visual data may be related to the user characteristics. For example, physiological characteristics related to the shape of the body, such as fingerprint, palm veins, facial features, DNA, palm print, hand geometry, iris recognition, retina, etc.

The processing unit may further be configured with a memory component. The memory component may be storing user data. User data may be the data collected from the user without compromising with the data privacy laws. The processing unit may further comprise a peripheral interface configured to enable at least one short distance communication between the authenticating sensor and the processing unit. The processing unit may further comprise at least one microcontroller containing one or more processor cores.

In some embodiments the authenticating sensor may comprise a transducer. The transducer may be configured to receive or transmit at least one acoustic signal. In some embodiments the acoustic signals may be the ultrasonic signal received or transmitted using an ultrasonic component. In some embodiments the authenticating sensor may comprise at least one piezoelectric knock sensor. The authenticating sensor may further comprise a magnetostriction oscillator to emit an ultrasonic signal.

In some embodiments the enclosing structure of the mobile robot may comprise an automated kinetic component. The automated kinetic component may be configured to detect a presence or absence of a user. The processing unit may be sending the user related data to the automated kinetic component. The mobile robot may further comprise a capacitive proximity sensor to detect the presence or absence of the user. The capacitive proximity sensor may be configured to send at least one signal to the automated kinetic component. The capacitive proximity sensor may send the signal of closing or opening the enclosing structure when the absence or presence of the authorised user is detected. The capacitive proximity sensor can also be a unidirectional sensor which can be activating the kinetic component when a stimulus approaches from at least one pre-determined direction. The automated kinetic component may further send a locking instruction to the locking component after a pre-determined time after the closing of the enclosing structure. The locking component may further comprise a solenoid lock configured to receive at least one open or close command from the capacitive proximity sensor.

In some embodiments the mobile robot may be configured with a graphic display. The graphic display may comprise a capacitive touch screen. This can be advantageous for user-robot interaction and/or entering an OTP for the user authorisation.

In a second embodiment a method for secure delivering of items is disclosed. The method comprising the step of loading the mobile robot, preferably the item space of the mobile robot, with the item to be delivered. The method comprising locking the enclosing structure of the mobile robot so as to prevent access to the item space. The method further comprising associating at least one or a plurality of authenticating techniques with the at least one item(s) to be delivered and the mobile robot. It should be noted that the order in which the steps are recited in this text may be accidental. That is, unless otherwise specified or unless clear to the skilled person, the order in which steps are recited may be accidental. For example, the authenticating technique may be associated before the item is loaded in the mobile robot. In some embodiments, a user terminal configured to exchange data with a processing unit. The user terminal can comprise a personal computing device such as a smartphone, tablet, laptop, wearable computing device or the like. The user terminal may be configured to access the user interface (which may comprise a program such as an app). The access may comprise the robot automatically unlocking the lid once the user is authenticated via the authenticating sensor. Then, the lid may open (e.g. rise) automatically and/or the user may be able to lift it manually.

In some embodiments the method may comprise the step of automatically generating an identification (ID) associated with each item and further may be inputting the ID of the item into the processing unit. In some embodiments the ID may be automatically inputted to a server. The processing unit may be configured to be installed to the mobile robot. The method may further comprise the step of enabling a bilateral data exchange between the processing unit and the server. The server may comprise a collection of servers, a cloud server, a distributed computing network of the like. The server may be in charge of a plurality of mobile robots. The server may have a storing unit configured to store user terminal data and/or the item ID. The server may be installed in a hub or an item loading warehouse. The server may be equipped with an item reader. The item reader may be further configured to scan or read the item ID. The server may also associate the authenticating technique to the item based on the ID and transmit the authenticating technique information to the mobile robot the item is being loaded. The ID of the item may contain information about at least one type of the item. This is particularly advantageous to associate the authenticating technique for the item. The type of the item may be automatically read/scanned at the hub. For example, the type may comprise ‘an important document’ or ‘groceries’ or a monetary value of the item. The ID may also comprise parameter of the item, for example, geometry, shape or size. This is particularly advantageous for the server to find an appropriate item space (in the mobile robot). In some embodiments, the item may comprise a user preferred security level and/or a user preferred convivence level. For example, if a user wants to deliver an item with extra security or with less security, this can be encoded in the item ID. The ID may further comprise sender data, such as address, contact information and/or the receiver data, such as, receivers address etc.

In some embodiments, the ID may be automatically generated by the server. For example, if a carton of milk is to be delivered, the server may scan the carton and automatically put the type ‘groceries’ ‘perishable’ and associate at least one authenticating technique for the delivery. The ID may be a machine-readable code, a RFID chip, an NFC tag or the alike affixed to the item. In some embodiments the server may be communicating the item ID to the processing unit of the mobile robot. The ID may further be configured with at least one of delivery location and delivery time.

In some embodiments, the authenticating sensor of the mobile robot may be configured to receive the ID and communicate it to the processing unit. In such embodiments, the processing unit may be configured to associate the authenticating technique(s) to the item. In some further embodiments, the authenticating technique may be associated based on an automatically generated security score of the item. For example, if a sender is transporting a highly important document then the server might assign an authenticating technique with a higher technique security score to the item with high security score. In a further embodiment the security score may be generated based on the ID of the item. The security score may be configured to be generated by the processing unit and/or the server.

The server and/or the processing unit may further be configured to assign at least one authenticating technique to the user terminal. The authenticating technique may comprise at least one of least one short range wireless communication, such as Bluetooth® or WIFI and at least one ultrasonic communication and at least one visual recognition and at least one audio recognition and at least one one-time password (OTP) verification and at least one biometric identification.

In a further embodiment, a convenience score may be generated for the item. The convenience score may be generated by the server and/or the processing unit. And a technique convenience score may be generated for each authenticating technique. The technique convenience score and/or the technique security score may be generated based on a type of input required to activate the respective authentication sensor. In a further embodiment the technique security score and/or the technique security score may be generated based on a type of communication protocol required to activate the respective authenticating sensor. In such embodiments, the authenticating technique may be associated with the item in such a way that the convivence score and the security score is optimised. In a further embodiment the authenticating techniques with similar or similar technique security score and/or the security score lying within a pre-determined value may be grouped in a first group. Further, the authenticating technique with same or similar and/or the convenience score lying within a pre-determined value may be grouped in a second group. In such embodiments the first group or the second group may be associated with the item. This is particularly advantageous when the mobile robot reaches the user terminal the authenticating technique may be associated from the group based on a user terminal availability. For example, short range wireless communication for authentication may have the same technique security score as ultrasonic communication, in such a case short-range wireless communication and ultrasonic communication may be grouped in the first group. Further, the item needed to be delivered has a security score matched to this group. In such an embodiment, the user terminal may choose any of the authenticating technique from the first group. If the user terminal is configured with a Bluetooth device it may choose a short-range wireless communication. If, the user terminal is equipped with an ultrasonic transducer it may choose the ultrasonic communication.

In a further embodiment the server may be configured to load the item(s) with the associated authenticating technique from the same first group and/or the same second group in the at least one mobile robot. Further, loading the item with the security score and/or the convenience score within a pre-determined threshold in the one mobile robot. This is particularly advantageous for delivering same or similar valued items efficiently. In some embodiment, where the user terminal has no choice the mobile robot may randomly pick an authenticating technique or decide on the basis of the technique convenience score. In some further, embodiments, the item may be loaded in a mobile robot based on the security score. For example, if the security score is higher than a threshold value then the item may be loaded separately in one mobile robot. In such embodiments the authenticating technique may also be associated from a plurality of the first group. For example, if the security score ranges from 0 to 1 with 0 being the lowest security needed and 1 being the highest security needed. The processing unit and/or the server may generate a security score of the item based on the type. For example, an item needed to be delivered has a monetary value more than a fixed threshold value such that the security level generated for the item is 0.7. In such an embodiment the server and/or the processing may associate one or more first groups to the item such that the technique security score is at least more than 0.7.

Each technique security score may be automatically generated by also optimising the technique convenience score. In some embodiments, the server and/or the processing unit may generate a second ID for the item. The second ID may comprise the ID and the authenticating technique associated with the item. The second ID may be a QR code, RFID tag or the alike affixed to the item. This will be advantageous when the item is being loaded in the mobile robot. The mobile robot can automatically register the information and use that at the user terminal. It may be noted that the technique security score and the technique convenience score may follow an inverse proportionate relationship. The server and/or the processing unit may associate an optimised authenticating technique to the item based on the technique security score and the technique convenience score. In some embodiments the user terminal may be sent the authenticating technique data when the item is being loaded in the mobile robot.

In a further embodiment, the processing unit may be configured to enable a bilateral data exchange between the user terminal and the mobile robot. In such embodiments the authenticating sensor may be configured to sense the user terminal at the delivery location. In a further embodiment the processing unit may be configured to automatically activate the authenticating sensor when the mobile robot is within a pre-determined distance of the user terminal. The bilateral data exchange may only be enabled when the mobile robot is in a pre-determined distance range of the user terminal. For example, 10 m to 1000 m in some embodiments. The mobile robot and the user terminal may first initiate a handshaking process to verify each other before starting the data exchange. The handshaking process may comprise the user terminal and/or the mobile robot sending an inquiry and the mobile robot and/or the user terminal respectively responding to the inquiry. In some embodiments, the processing unit and/or the mobile robot may be in active mode. The active mode may comprise the user terminal and/or the mobile robot is actively transmitting or receiving data. This may be particularly advantageous when the mobile robot is in a densely populated area. For example, selling coffee in a college campus. The mobile robot may be in active mode so it can be easily spotted all the time. In a further embodiment, the user-terminal and/or the processing unit may be in park mode. The park mode may comprise the processing unit and/or the user terminal becomes inactive until a wake-up signal is received. This could be an efficient way. In some embodiments the processing unit and/or the user terminal may be in sniff mode, wherein the user terminal and/or the processing unit is only active in pre-determined time intervals. For example, for delivering lunch in a college/office campus the processing unit is only active between 11:00 and 14:00.

In some embodiments the authenticating sensor may be configured to authenticate the at least one user at a delivery location to access the item space of the mobile robot. The authentication may be facilitated by the authenticating sensor. The processing unit may further be configured to provide the access by transmitting an unlock and/or open command to the locking component. In some embodiments the enclosing structure such as the lid may automatically open, such as rise after receiving the unlock command.

In some embodiment the user terminal may be authenticated to access the item space via the authenticating sensor. The authenticating sensor may further comprise an ultrasonic transducer configured to emit and receive ultrasonic waves. In such embodiments, the authenticating sensor will not only be able to detect the presence of the user but also identify the position of the user, preferably via echo ranging. In such embodiments, the authenticating sensor may further be configured to determine a direction of motion of the user, preferably via dopplers effect. In a further embodiment the authenticating sensor may be equipped with an audio recognition component. In such an embodiment, a history data of the user terminal may be stored in the memory component. Using the history data, the processing unit may be trained to recognise at least one user speech sample. The authenticating sensor may be receiving the user speech sample via the audio recognition component, which may be equipped with a microphone in some embodiments. Additionally, or alternatively, the user speech sample may comprise a specific sentence and/or a phrase, for example ‘Could I have the parcel number 3687F87’ and the processing unit may be configured to provide the access upon detecting this specific sentence and independently of a particular voice. In such embodiments, the processing unit may be configured with an intelligent virtual assistant. Furthermore, the processing unit may be configured to send a specific phrase/sentence to the user terminal, preferably via a user interface prior to the delivery.

In a further embodiment, the audio recognition may be comprising the technique security score higher than the short-range wireless communication. In such embodiments, the audio recognition may be used alone for a higher security score or in combination with the short-range communication based on the security and convenience score of the item. In a further embodiment the authenticating sensor may be equipped with a piezoelectric knock sensor. In such an embodiment, the user terminal may be sent a one time or a long-term knock code and by inputting the knock code the user may authorise to access the item. The authenticating technique using the piezoelectric knock sensor may comprise a security score in the range of 0.5-0.7 and the convenience score of 0.3-0.5. Whereas the short-range wireless communication may comprise a convenience score of 0.6-0.9, since, the wireless communication may provide the access with just one tap on the user terminal.

In a further embodiment, the security score may be configured to be generated based on the delivery location of the item. In such embodiments the processing unit can be configured to extract the receiver and/or delivery location from the ID of the item, and decide the security score based on a historical data saved in the memory component. For example, if the historical data labels a specific area as ‘less safe’, the security score may be higher. The security score may also be generated in combination with delivery time data, for example if the historical data labels a specific area unsafe for a specific time only, the security score will be generated accordingly.

In some embodiments the authenticating sensor may comprise a camera configured with visual recognition of the user terminal. The visual recognition may comprise a visual code sent to the user terminal, such as a bodily motion originating from face or hand. The visual recognition may also comprise facial recognition on the basis of the user visual data saved in the processing unit. In some embodiments the user terminal may be authenticated to access the item using the at least one OTP (one-time password) sent to the user. The one-time password may be at least one alphanumeric code, the at least one user visual data, the at least on user sample speech, at least one biomarker, the at least one knock code. When the mobile robot arrives the user-terminal, based on the authenticating technique associated with the item the processing unit may ask for the at least one OTP from the user terminal.

In a further embodiment, the mobile robot may be configured with a graphic display. The graphic display may further be configured with a capacitive touch. The graphic display further configured with receiving at least on at least one tap code and at least one pattern. In some embodiments the authenticating technique used can be biometric identification. The biometric identification may comprise the automatically associated technique convivence score and the technique security score. In such embodiments the processing unit and/or the server may be configured to store at least one user biomarkers. The authenticating sensor may receive the at least one user biomarker and may authenticate the user by matching the user biomarker with the stored user biomarker. The user biomarker may comprise, fingerprints, iris scan, DNA, facial features and the alike.

In a further embodiment, the method may be comprising changing the technique security score and the technique convivence score based on a user feedback.

In a third embodiment a system configured to securely deliver items is disclosed. The system comprises at least one server adapted for receiving, storing and sending item data. The system further comprises the mobile robot. Further, the system is configured to perform the method as disclosed above. The system further comprises an authenticating sensor configured to provide an access to the item.

The mobile robot can be an autonomous or a semi-autonomous robot configured for ground-based travel. Note, that as used herein, the terms autonomous or semi-autonomous robot can be used to mean any level of automation depending on the task that the robot is performing. That is, the robot can be adapted to function autonomously or semi autonomously for most of the tasks, but can also be remotely controlled for some other tasks. Then, the robot would be non-autonomous during the time it is controlled, and then autonomous and/or semi-autonomous again when it is no longer controlled. For example, the robot can assume any of the levels of automation as defined by the Society of Automotive Engineers (SAE), that is, the levels as given below.

Level 0—No Automation

Level 1—Driver Assistance

Level 2—Partial Automation

Level 3—Conditional Automation

Level 4—High Automation

Level 5—Full Automation

Though the levels usually refer to vehicles such as cars, they can also be used in the context of the mobile robot. That is, Level 0 can correspond to a remote terminal fully controlling the robot. Levels 1-4 can correspond to the remote terminal partially controlling the robot, that is, monitoring the robot, stopping the robot or otherwise assisting the robot with the motion. Level 5 can correspond to the robot driving autonomously without being controlled by a remote terminal such as a server or a remote operator (in this case, the robot can still be in communication with the remote terminal and receive instructions at regular intervals).

The present invention is also defined by the following numbered embodiments.

### Numbered Embodiments

Below, mobile robot embodiments will be discussed. These embodiments are abbreviated by the letter “D” followed by a number. Whenever reference is herein made to “mobile robot”, these embodiments are meant.

D1. A mobile robot configured to transport at least one item to a user, wherein the mobile robot comprises:
a body comprising an item space;
at least one authenticating sensor, configured to sense at least one user terminal;
at least one processing unit,
at least one enclosing structure configured to cover the item space,
at least one locking component configured to lock the enclosing structure to the body.

D2. The mobile robot according to the preceding embodiment wherein the robot authenticating sensor comprises a camera configured to capture image of the surroundings of the robot.

D3. The mobile robot according to any of the preceding embodiments wherein the robot is configured with a plurality of cameras.

D4. The mobile robot according to any of the preceding embodiments wherein at least one camera is placed at the enclosing structure, so as to have a field of view at least partially above and to the front of the mobile robot.

D5. The mobile robot according to any of the preceding embodiments wherein at least one camera is installed at a frame of the robot's body.

D6. The mobile robot according to any of the preceding embodiments wherein the mobile robot further comprises an elongated visibility device and wherein the visibility device comprises a camera at or near its highest vertical point.

D7. The mobile robot according to any of the preceding embodiments wherein the processing unit is configured to construct at least one surrounding data based on the plurality of image data captured by the plurality of cameras.

D8. The mobile robot according to any of the preceding embodiments wherein the authenticating sensor comprises a scanner configured to scan visual data.

D9. The mobile robot according to any of the preceding embodiments wherein the scanner further comprises a camera.

D10. The mobile robot according to any of the preceding embodiments wherein the scanner is configured to scan at least one object and further convert it into at least one digital data, preferably via the processing unit.

D11. The mobile robot according to any of the preceding embodiments wherein the mobile robot is configured to enable a bilateral data exchange between the authenticating sensor and the processing unit.

D12. The mobile robot according to any of the preceding embodiments and features of D1 wherein the processing unit comprises at least one memory component.

D13. The mobile robot according to the preceding embodiment wherein the processing unit comprises at least one peripheral interface.

D14. The mobile robot according to the preceding embodiment wherein the processing unit comprises at least one microcontroller.

D15. The mobile robot according to any of the preceding embodiments, wherein the authenticating sensor comprises at least one or a plurality of transducers.

D16. The mobile robot according to the preceding embodiment wherein the at least one transducer is configured to be installed at the body of the mobile robot.

D17. The mobile robot according to the preceding embodiment wherein the transducer is configured to receive at least one acoustic signal.

D18. The mobile robot according to the preceding embodiment wherein the transducer is configured to transmit at least one acoustic signal.

D19. The mobile robot according to any of the preceding embodiments wherein the processing unit is configured to generate surrounding data based on the sent and/or received acoustic signal by the authenticating sensor.

D20. The mobile robot according to any of the preceding embodiments wherein the authenticating sensor comprises at least one piezoelectric knock sensor.

D21. The mobile robot according to the preceding embodiment wherein the enclosing structure of the mobile robot is configured with the piezoelectric knock sensor.

D22. The mobile robot according to the preceding embodiment wherein the transducer comprises a magnetostriction oscillator configured to emit an ultrasonic signal.

D23. The mobile robot according to any of the preceding embodiments wherein the enclosing structure of the mobile robot is configured with an automated kinetic component configured to actuate the enclosing structure so as to expose the item space.

D24. The mobile robot according to the preceding embodiment wherein the authenticating sensor is configured with a proximity sensor configured to send at least one signal to the automated kinetic component.

D25. The mobile robot according to the preceding embodiment wherein the enclosing structure of the mobile robot is configured with the proximity sensor.

D26. The mobile robot according to any of the preceding embodiments wherein the locking component is configured with a proximity sensor.

D27. The mobile robot according to any of the preceding embodiments wherein the locking component is configured to automatically lock the enclosing structure to the mobile robot.

D28. The mobile robot according to the preceding embodiment wherein the locking component comprises a solenoid lock configured to receive at least one command from the proximity sensor.

D29. The mobile robot according to any of the preceding embodiments wherein the item space is configured to hold the at least one item.

D30. The mobile robot according to the preceding embodiment wherein the item space comprises at least one item compartment.

D31. The mobile robot according to any of the preceding embodiments wherein the mobile robot comprises a graphic display.

D32. The mobile robot according to the preceding embodiment wherein the graphic display further comprises a capacitive touch screen.

D33. The mobile robot according to any of the preceding embodiments wherein the authenticating sensor is configured with a short range communication protocol further configured to communicate with a user terminal.

D34. The mobile robot according to any of the preceding embodiments wherein the processing unit is configured to pull at least one audio data from the user terminal.

D35. The mobile robot according to any of the preceding embodiments wherein the mobile robot further comprises a memory component and wherein the memory component is configured to store at least one past user data.

D36. The mobile robot according to any of the preceding embodiments wherein the processing unit is configured to authenticate the user, preferably based on past user data.

D37. The mobile robot according to any of the preceding embodiments wherein the processing unit is further configured to activate the authenticating sensor at a user location.

Below, method embodiments will be discussed. These embodiments are abbreviated by the letter “M” followed by a number. Whenever reference is herein made to “method embodiments”, these embodiments are meant.

M1. A method for secure and convenient delivering of items, the method comprising:
loading a mobile robot, according to any of the preceding mobile robot embodiments, with at least one item to be delivered;
locking an enclosing structure to the mobile robot so as to prevent access to the item space; and
associating at least one or a plurality of authenticating techniques with the item to be delivered and/or the mobile robot

M2. The method according to any of the preceding embodiments wherein the method comprises the step of automatically inputting at least one identification (ID) of the item into a processing unit.

M3. The method according to any of the preceding embodiments wherein the method comprises the further step of enabling a bilateral data exchange between the processing unit of the robot and a server.

M4. The method according to the preceding embodiment wherein the server comprises a remote and/or a local operator.

M5. The method according to any of the preceding embodiment and features of M2 wherein the ID of the item comprises at least one of:
at least one type of the item;
parameter data of the item;
at least a user preferred security level;
at least a user preferred convenience level;
sender data;
receiver data.

M6. The method according to any of the preceding embodiments and with features of embodiment M3 wherein the method comprises the further step of automatically generating the at least one ID for the item by the server.

M7. The method according to any of the preceding embodiments wherein the method comprises a further step of automatically connecting the mobile robot to at least one loading station.

M8. The method according to the preceding embodiment and with features of embodiment M3 wherein the method comprises the step of associating the at least one loading station with the at least one server.

M9. The method according to any of the preceding embodiments and with features of embodiment M2 wherein the ID comprises at least one of a machine-readable code, a RFID chip, an NFC tag.

M10. The method according to the preceding embodiment and features of M2 wherein the method comprises the step of receiving the at least one ID via an authenticating sensor of the mobile robot.

M11. The method according to any of the preceding embodiments and with features of embodiments M2 and M7 wherein the method further comprises the step of receiving the ID via an ID scanner at the loading station.

M12. The method according to the preceding embodiment and with features of embodiment M3 wherein the ID scanner is configured to transmit the received ID to the server.

M13. The method according to any of the preceding embodiments and with features of embodiments M2 and M3 wherein the method comprises the further step of automatically pulling the ID by the processing unit from at least one of the at least the authenticating sensor and at least the server.

M14. The method according to any of the preceding embodiments wherein the at least one authenticating technique comprises at least one of:
at least one short range wireless communication;
at least one ultrasonic communication;
at least one visual recognition;
at least one audio recognition;
at least one one-time password (OTP) verification;
at least one biometric identification.

M15. The method according to any of the preceding embodiments wherein the method comprises the step of automatically generating a security score associated with the item by at least one of at least the processing unit and at least the server.

M16. The method according to the preceding embodiment wherein the security score is generated based on the ID of the item.

M17. The method according to any of the two preceding embodiments wherein the security score is generated based on a delivery data of the item.

M18. The method according to any of the preceding embodiments and with features of embodiment M2 wherein the method further comprises the step of automatically generating at least one convenience score based on the ID of the item.

M19. The method according to the preceding embodiment wherein the method comprises automatically generating the convenience score by at least one of the at least the processing unit and at least the server.

M20. The method according to any of the preceding embodiments wherein the method comprises the step of generating at least one technique security score associated with the at least one authenticating technique.

M21. The method according to any of the preceding embodiments wherein the method comprises the step of generating at least one technique convenience score associated with the at least one authenticating technique.

M22. The method according to any of the two preceding embodiments wherein the method comprises the step of generating the at least one technique security score and/or the at least one technique convenience score based on a type of input required to activate the authenticating sensor.

M23. The method according to any of the preceding embodiments wherein the method comprises the step of generating the at least one technique security score and/or the at least one technique convivence score based on a type of communication protocol required to activate the authenticating sensor.

M24. The method according to any of the preceding embodiments wherein the method comprises the step of grouping the at least two authenticating techniques with same or similar technique security score in at least a plurality of first groups.

M25. The method according to the preceding four embodiments wherein the method comprises the step of grouping the at least two authenticating techniques with same or similar technique convenience score in at least a plurality of second groups.

M26. The method according to any of the two preceding embodiments wherein the method comprises the step of associating at least one of the at least the first group and at least the second group with the item.

M27. The method according to any of the six preceding embodiments wherein the method comprises the step of automatically associating at least one authenticating technique to the item based on the at least one of the at least the security score and at least the convenience score.

M28. The method according to any of the seven preceding embodiments wherein the method comprises the step of automatically associating at least one authenticating technique to the item based on the at least one of the at least the technique security score and at least the technique convenience score.

M29. The method according to any of the six preceding embodiments wherein the method comprises the further step of loading the item with the associated authenticating technique from the same first group and/or the same second group in the at least one mobile robot.

M30. The method according to any of the nine preceding embodiments wherein the method comprises the step of automatically loading the item with the security score and/or the convenience score within a pre-determined threshold in the one mobile robot.

M31. The method according to any of the preceding embodiments wherein the method comprises the step of storing the authenticating technique associated with the item in a memory component.

M32. The method according to any of the nine preceding embodiments wherein the method comprises the step of automatically associating the at least two authenticating techniques from the at least two first groups if the security score is greater than a pre-determined threshold value.

M33. The method according to any of the preceding embodiments wherein the method further comprises facilitating each authenticating technique at the user terminal via the at least one authenticating sensor.

M34. The method according to any of the preceding embodiments wherein the method comprises the further step of automatically activating the appropriate authenticating sensor when the mobile robot is within a pre-determined distance of the user terminal.

M35. The method according to any of the preceding embodiments wherein the method comprises the further step of automatically activating the appropriate authenticating sensor based on the associated authenticating technique when the mobile robot is within a pre-determined distance of the user terminal.

M36. The method according to any of the preceding embodiments and with features of embodiments 24 and 25 wherein the method comprises the further step of automatically activating the appropriate authenticating sensor based on the associated first group and/or second group when the mobile robot is within a pre-determined distance of the user terminal.

M37. The method according to any of the preceding embodiments and with features of embodiments 24 and 25 wherein the method comprises the further step of automatically activating the appropriate authenticating sensor based on at least one of the associated first group and/or second group and at least a user terminal authenticating sensor when the mobile robot is within a pre-determined distance of the user terminal.

M38. The method according to any of the preceding embodiments wherein the method comprises the step of enabling a bilateral data exchange between the user terminal and the mobile robot when the mobile robot is within a pre-determined distance of the user terminal.

M39. The method according to the preceding embodiment wherein the pre-determined distance comprises a distance range of 10 m to 1000 m.

M40. The method according to the preceding two embodiments wherein establishing a bilateral data exchange comprises a mobile robot communication component sending an inquiry request to the user terminal.

M41. The method according to the preceding embodiment wherein establishing a bilateral data exchange further comprises the user terminal responding with at least one user terminal ID.

M42. The method according to the preceding embodiment wherein establishing a bilateral data exchange further comprises the step of verifying the user terminal ID and forming a connection.

M43. The method according to the preceding embodiment wherein establishing a bilateral data exchange comprises the user terminal sending the inquiry request to the communication component.

M44. The method according to the preceding embodiment wherein establishing a bilateral data exchange further comprises the communication component responding with at least one robot ID.

M45. The method according to the preceding embodiment wherein establishing a bilateral data exchange further comprises the step of verifying the robot ID and forming a connection.

M46. The method according to any of the preceding seven embodiments wherein the method further comprises setting the processing unit and/or the user terminal in at least one mode:
active mode, where the at least one user terminal and/or the processing unit is actively transmitting or receiving data;
park mode, where the user terminal and/or the processing unit becomes inactive until the processing unit and/or the user sends a wake-up signal;
sniff mode, where the user terminal and/or the processing unit is only active in pre-determined time intervals.

M47. The method according to any of the preceding embodiments wherein the method further comprises authenticating the at least one user terminal to access the at least one item via the authenticating sensor.

M48. The method according to the preceding embodiment wherein the authenticating sensor transmits ultrasonic waves within a pre-determined range.

M49. The method according to the preceding embodiment wherein the method comprises the further step of receiving the ultrasonic wave by the user terminal equipped with a user authenticating sensor.

M50. The method according to any of the preceding embodiments wherein the method further comprises determining a position of the user terminal using the authenticating sensor.

M51. The method according to any of the preceding embodiments wherein the method comprises the step of determining the position of the user terminal via echo ranging.

M52. The method according to any of the preceding embodiments wherein the method comprises determining a direction of motion of the user terminal preferably via doppler effect.

M53. The method according to any of the preceding embodiments wherein the method comprises the step of authenticating the user to access the item via audio recognition.

M54. The method according to the preceding embodiment and with features of embodiment M49 wherein the method comprises the step of recording at least one user speech sample from the at least one user terminal via the user authenticating sensor and/or the authenticating sensor.

M55. The method according to the preceding embodiment wherein the method comprises the further step of storing at least one user dependent training speech sample in the server and/or the processing unit.

M56. The method according to any of the preceding embodiments wherein the method comprises the step of authenticating the at least one user to access the item by verifying at least one user speech sample.

M57. The method according to any of the preceding embodiments the method comprises the further step of authenticating the user via the authenticating sensor configured with a piezoelectric knock sensor.

M58. The method according to the preceding embodiment wherein the method comprises the step of sending the user terminal at least one long-term and/or one-time knock code.

M59. The method according to the preceding two embodiments and with features of embodiment M49 wherein the method comprises the step of inputting at least one user knock code to at least one of the at least the user authenticating sensor and at least the authenticating sensor.

M60. The method according to the preceding two embodiments wherein the method comprises the further step of verifying the user knock code with knock code to authenticate the user terminal to access the item.

M61. The method according to any of the preceding embodiments wherein the step of accessing the item is facilitated by the processing unit automatically unlocking a locking component of the mobile robot.

M62. The method according to any of the preceding embodiments wherein the method comprises the step of authenticating the user terminal to access the item via the authenticating sensor configured with the visual recognition technique.

M63. The method according to the preceding two embodiments wherein the method comprises the further step of sending at least one long-term and/or one-time visual recognition code to the user terminal via the processing unit.

M64. The method according to the preceding embodiment wherein the visual recognition code comprises a bodily motion preferably originating from face or hand.

M65. The method according to the preceding four embodiments wherein the method further comprises inputting a user visual data via the authenticating sensor to the processing unit.

M66. The method according to any of the preceding four embodiments and with features of embodiment M49 wherein the method further comprises inputting a user visual data via the user authenticating sensor to the processing unit.

M67. The method according to any of the preceding embodiments and features of M13 wherein the method comprises the step of authenticating the at least one user to access the item via the OTP verification.

M68. The method according to the preceding embodiment wherein the OTP comprises at least one of:
at least one alphanumeric code,
the at least one user visual data,
the at least on user sample speech,
at least one biomarker,
the at least one knock code.

M69. The method according to the preceding embodiment the method further comprises sending at least one pattern and/or a tap code to the user terminal.

M70. The method according to the preceding embodiment further comprising the step of inputting at least one user tap code and/or pattern on a graphic display for verification.

M71. The method according to any of the preceding embodiments and features of M13 wherein the method comprises the step of authenticating the at least one user to access the content via biometric identification.

M72. The method according to the preceding embodiment wherein the method comprises storing at least one user biomarker in the processing unit.

M73. The method according to the preceding embodiment wherein the method comprises storing the at least one user biomarker data in the server.

M74. The method according to any of the preceding embodiments wherein the method comprises identifying the at least one user by evaluating the at least one user biomarker data.

M75. The method according to the preceding four embodiments wherein the method comprises the step of inputting the at least one user biomarker data preferably via the authenticating sensor.

M76. The method according to the preceding five embodiments wherein the user dependent biomarker data comprises at least one of:
fingerprints,
iris scan,
DNA,
facial features.

Below, system embodiments will be discussed. These embodiments are abbreviated by the letter “S” followed by a number. Whenever reference is herein made to “system embodiments”, these embodiments are meant.

S1. A system configured to securely deliver items, the system comprising:
at least one server adapted for receiving, storing, and sending item data;
a mobile robot according to any of the preceding mobile robot embodiments; and the system further configured to provide access to at least one user at a delivery location.

S2. The system according to the preceding embodiment wherein the system is configured to perform the method according to any of the preceding method embodiments.

S3. The system according to any of the preceding embodiments wherein the mobile robot is configured with a processing unit, configured to pull at least one item ID.

S4. The system according to any of the preceding embodiments wherein the server is configured to automatically receive the item ID.

S5. The system according to any of the preceding embodiments wherein the server and the processing unit are configured to enable a bilateral data exchange.

S5. The system according to any of the preceding embodiments wherein the processing unit and/or the server is configured to automatically associate at least one authenticating technique to the item.

S6. The system according to the preceding embodiment wherein the authenticating technique is configured to be associated based on at least one security score.

S7. The system according to any of the two preceding embodiments wherein the authenticating technique is configured to be automatically associated based on at least one convenience score.

S8. The system according to any of the preceding embodiments wherein at least one of the at least the security score and at least the convenience score is automatically generated based on the ID of the item.

S9. The system according to any of the preceding embodiments wherein a plurality of the authenticating techniques is configured to be associated with the item.

S10. The system according to any of the preceding embodiments wherein the authenticating sensor is configured to authorize at least one user terminal to access the item.

### BRIEF DESCRIPTION OF THE DRAWINGS

FIG. 1 shows a schematic flowchart of an autonomous and automatic item transporting method according to one embodiment;

FIG. 2 illustrates an exemplary embodiment of a mobile robot comprising at least one autonomous locking element.

FIG. 3 lists a plurality of facilitating techniques for authenticating at least one user.

FIG. 4 shows a schematic flowchart of a security assigning method according to one embodiment.

FIG. 5 shows an exemplary communication according to one embodiment.

### DETAILED DESCRIPTION

In the following, exemplary embodiments of the invention will be described, referring to the figures. These examples are provided to provide further understanding of the invention, without limiting its scope.

In the following description, a series of features and/or steps are described. The skilled person will appreciate that unless required by the context, the order of features and steps are not critical for the resulting configuration and its effect. Further, it will be apparent to the skilled person that irrespective of the order of features and steps, time delays between steps can be present between some or all of the described steps.

The description of the figures first provides a general overview of embodiments of the present invention, before providing further details of more specific embodiments, features and steps of the exemplary embodiments of the present invention.

Embodiments of the present invention relates to methods and systems comprising a mobile robot 100 that may travel autonomously (without a human operator controlling it) or semi-autonomously (with a human operator only controlling it at some times during its operation). Such a robot 100 can be used for transporting different types of item/s and/or services. It may sometimes be required for the mobile robot 100 to have at least some level of security while delivering an item.

The following distinction of different ways how the mobile robot can have at least one level of security and thus authenticate at least one recipient to access an enclosed item space 101 of the mobile robot 100.

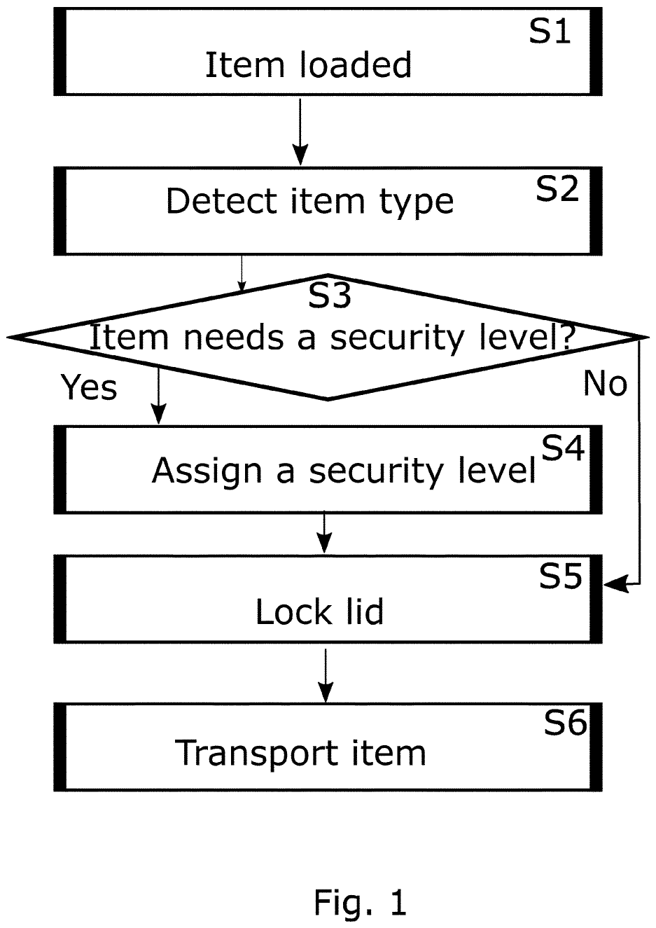

FIG. 1 shows a schematic flowchart of an automatic and autonomous transporting method. The method concerns a mobile robot 100 which is required to control the dynamics of an enclosing structure 103. The enclosing structure can be a lid or a door enclosing the mobile robot's item space. The method concerns a mobile robot 100 which is required to transport an item. Thus, in a first step S1 the method can initialize with an item loaded in the enclosed space or the item space 101 of the mobile robot. Wherein at least one removable container can be installed to the enclosed item space 101. The container can also be a container fixed to the enclosed item space 101. The container can also comprise at least one compartment. It should be noted that S2 may be performed before S1, such that the item type is detected first and then it is loaded in the mobile robot.

When the item is placed or installed in the item space, the method can comprise detecting a type of the item S2. The type of item can comprise a weight and/or size of the item. The type can also comprise a quality of an item, such as fragility, shelf life of an item, etc. Further, a server 500 can be configured with a list of items being categorised on the basis of type. The sever 500 can be trained with labelled and/or unlabelled content data to predict a type of the item. A sender can be configured to enter the content of the item in the sever. The content can comprise the content of the item to be transported, for example, documents, coffee, pizza, etc.

The type can further comprise a monetary value, importance value, etc. The item in one embodiment can comprise an ID, comprising a machine-readable code, RFID chip, NFC tag, etc. The ID can be configured to contain the at least type of the item, sender data, receiver data of the item. In one embodiment the ID can comprise the sender and/or receiver address. The server 500 can comprise a reader, scanner to at least read the ID of the item.

The mobile robot 100 can comprise a processing unit. The processing unit may contain memory, a peripheral interface, at least one microcontroller. The mobile robot 100 can further be configured with scanner to read/scan the ID of the item being installed in the mobile robot 100. Further, the server 500 may be communicating the item type and/or ID to the mobile robot.

When the at least one item is loaded in the robot 100, the server 500 can further communicate to the robot 100 if the item needs a security level S3. The security level can be the security score. The container and/or the enclosed space 101 can be configured with at least one load cell sensor. The load cell sensor can be installed at base where item is supported. The base can be the surface on which the item is installed.

The security level/security score can also be determined by at least one user recipient preference. The method can further be comprising step S5 which can be configured to locking at least one lid (enclosing structure) of the container and/or the mobile robot. The lid 103 can also be automated or semi-automated. The lid 103 can be equipped with a capacitive proximity sensor. The lid 103 can be configured to detect a presence of a user and sending a signal to a kinetic component to cause the lid to move from a closed position to an open position. And the kinetic component moving the lid 103 from an open position to a closed position automatically after a pre-determined time interval. The kinetic component can be configured with an electric motor combined with a shaft to control the kinetics of the lid 103.

The motor can have the shaft connected to the lid 103 such that the rotation of the shaft in one direction can cause the lid to move from the open position to the closed position. And the rotation in an opposite direction can cause the lid 103 to move from the closed position to the open position. The electric motor can also be configured to connect with the processing unit of the mobile robot 100. And the processing unit can be configured to send at least one instruction to open and/or close the lid 103. The processing unit can further comprise a robot communication component. The robot communication component can be configured to communicate with the server 500 and/or the user U1, U2. The capacitive proximity sensor can also be a unidirectional sensor which can be activating the kinetic component when a stimulus approaches from at least one pre-determined direction.

The lid 103 can further comprise a locking component which can be further controlled by the processing unit. For example, the locking component can be a solenoid lock receiving electrical locking and/or unlocking signals from the processing unit.

The processing unit can be further equipped with sending a signal to the locking component only when the item is installed in the robot 100. The processing unit can also send a signal to the locking component after a pre-determined time has passed.

The step 6 can be to transport the item once it is loaded and locked to the mobile robot 100. The processing unit can comprise sending at least one command to a locomotive component comprising wheel 105 once the lid 103 is locked.

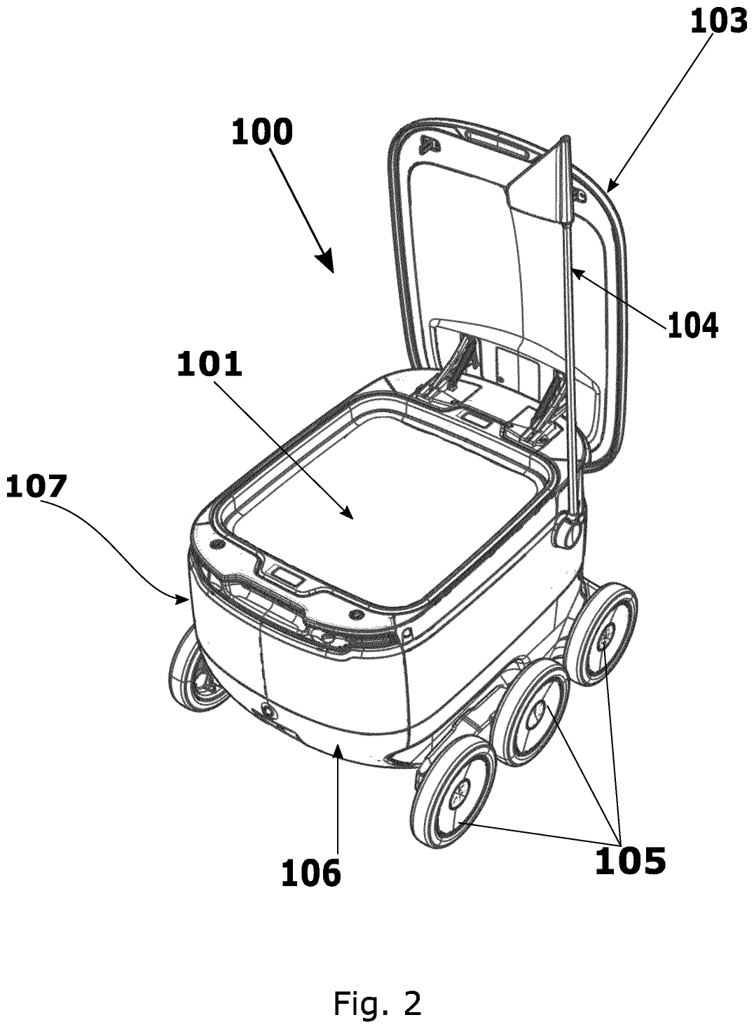

FIG. 2 shows an embodiment of a mobile robot 100. The robot 100 can comprise wheels 105 adapted for land-based motion. The wheels 105 can be mounted to a frame 106. A body 107 can be mounted on the frame 106. Body 107 can comprise an enclosed space 101. The enclosed space 101 can be configured to carry at least one item for transportation. Further, the mobile robot 100 can comprise a motion generation system (not shown), e.g., an electric and/or combustion engine, powered by battery and/or fuel. The mobile robot 100 can comprise the at least one processing unit (not shown) which can be programmed and/or configure to receive instructions from a user terminal U1, U2 and/or the server 500 e.g. remotely. The processing unit of the robot 100 can facilitate a partial or a fully autonomous operation of the mobile robot 100. The mobile robot 100 can comprise the communication component (not shown), such as, a wireless communication unit, e.g. a long-range wireless communication component. The communication component can be configured to allow the mobile robot 100 to send and/or receive data with at least one external and/or distant device or system, such as, another mobile robot, server, user terminal, remote controller, processing unit etc. The mobile robot 100 can also comprise a communication component configured for short range communication configured to allow the mobile robot 100 to communicate with at least one non-distant external device, such as, a remote controller.

In some embodiments, the mobile robot 100 can be a delivery robot 100. It can, for example, be configured to carry out last-mile delivery. That is, the robot 100 can be configured to receive at least one delivery item in the enclosed space 101. The robot 100 can receive an item at a sender location (e.g. a parcel shop, shop, bar, restaurant, storage location, a user's home, etc.) and can be configured to transport the item to a recipient location. The robot 100 may be configured to travel autonomously or semi-autonomously at least from the sender location to the recipient location. Preferably the robot 100 can be configured to travel (e.g. by default) in an autonomous mode (i.e. without a human operator assistance). In some embodiments, the robot 100 traveling in autonomous mode may be assisted by an external server. For example, the external server may carry out tasks requiring extensive computational resources and/or memory capacity. Additionally, the robot 100 may be configured to request a human operator assistance in some scenarios or instances, such as, more than usual dangerous scenarios, e.g. low uncertainty during a problem solving or decision taking, sensing unauthenticated trial in lock opening, etc. The robot 100 can be configured (or optimized) to maximize the autonomous driving time and minimize the number of requests and time for human operator assistance.

In other words, the mobile robot 100 can operate autonomously or partially autonomously. For example, the autonomy level of the mobile robot 100 can be between the levels 1 to 5, as defined by the Society of Automotive Engineers (SAE) in J3016-Autonomy Levels. In some embodiments the mobile robot 100 can be controlled (e.g. steered) by a human operator through a user terminal (i.e. the user terminal can exchange data with the mobile robot). In some other embodiments, the robot 100 is assisted by the human operator only in some instances, e.g. in particular situations imposing more risk, such as, unauthenticated lid opening. In other embodiments, the robot 20 can be fully autonomous—that is, can authenticate the at least one user U1, U2 to access the enclosed space 101 and carry out an assigned task without human intervention.

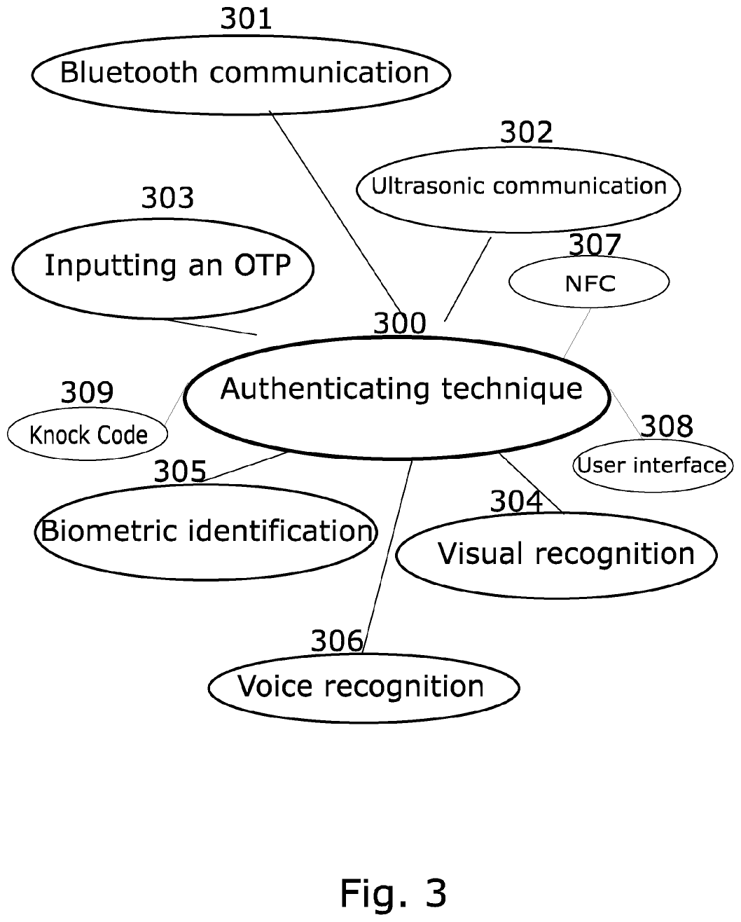

FIG. 3 lists a plurality of facilitating techniques for authenticating at least one user U1, U2 to access the enclosed space 101 of the mobile robot 100. In some embodiments, at least one technique listed in FIG. 3 for facilitating the authentication of a user can be performed to assign a security level to the mobile robot 100 as part of the method for assigning a security level S4 in FIG. 1. Bluetooth communication 301 can be configured with a Bluetooth lock. The communication component of the processing unit and the at least one user U1, U2 can be configured with a two-way Bluetooth wireless communication protocol. The user U1, U2 and/or the processing unit can be configured with a Bluetooth Low Emission (BLE) component. The U1, U2 can be further configured to unlock the lid of the mobile robot by connecting to the processing unit via the BLE component. When the user U1, U2 sends an unlock signal to the processing unit, the processing unit can be configured to open the lid of the mobile robot. The user U1, U2 configured with the BLE component can be configured to exchange data with at least one nearby processing unit. In some embodiments the user U1, U2 or the one of the users can be configured to be a master. In some other embodiments the user or the at least one user U1, U2 can be configured to be an active slave. Each user and/or the processing unit can be configured with at least one address that can further be configured to fall into a pre-determined range of addresses. When an actively searching, processing unit sends a radio signal only user with the address in a pre-determined range of address will hear. It can also be the other way, if the user is actively searching, the BLE component can be configured to only send the signal to the processing unit in the pre-determined range. Once the communication is authenticated the user can be configured open the lid of the robot.

The authenticating technique 300 can further comprise enabling the access of the user via the user terminal U1, U2 using a user interface (308). The user interface (308) may be configured with an app on a smartphone or a user device. The user interface (308) may be configured to receive the OTP and further authenticate the user to access the item space.

The ultrasonic communication 302 can be used as an authenticating technique 200. The processing unit can be further configured with an ultrasonic component. The user U1, U2 can also be configured with a user ultrasonic component. The user U1, U2 can be configured with an ultrasonic transmitter configured to transmit ultrasonic waves within a pre-determined frequency range. The processing unit can be configured with an ultrasonic receiver. Once, the communication is set the processing unit can be configured to send encrypted data to the user. The user can further be configured to decrypt the data and access the enclosed space of the mobile robot.

The processing unit can be configured to change an observed frequency if the ultrasonic receiver and/or the ultrasonic transmitter are not stationary relative to each other. This change in observed frequency can result in doppler shift, which can further comprise of determining the direction of motion of the ultrasonic transmitter and/or the ultrasonic receiver.

In some embodiments the authenticating technique 300 used can be inputting a one-time password (OTP) 303. The user U1, U2 can be configured with an identification code such as a bar code, a QR code, a RFID tags, etc. The processing unit can be configured with an active reader passive tag which can be configured to transmit interrogator signal and further can receive an authentication reply from the user. The processing unit can be further configured with an optical component configured to decode the identification code. Further, the identification code of the user can be configured to be the one-time password and/or a long-time password. The inputting an OTP 303 can further comprise the lid configured with a graphic display further configured with a capacitive touch. The user can further input a one-time identification code, a pattern, tap code, etc.

In some embodiments, when the mobile robot 100 arrives at the user location the user U1, U2 can authenticate by using biometric identification 305. The biometric identification 305 can comprise uniquely identifying the at least one user by evaluating at least one distinguishing biological trait. For example, the server 500 and/or the processing unit can comprise a database to store at least one user's biometric marker. The biometric markers can comprise, fingerprints, iris scans, DNA, facial features, etc. The mobile robot can comprise using the optical system to take an input biometric marker from the user and verify it with the stored database to provide an access to the user.

Another authenticating technique 300 used can be visual recognition, this can comprise the processing unit sending a visual recognition code to the user. The visual recognition code can be a one-time code or a long-term code. The visual recognition code can comprise a bodily motion. The bodily motion can originate from the face or hand. For example, the processing unit can send the visual recognition code for a particular user to be waving left hand left to right three times. The optical component can comprise sending an input recognition code to the processing unit and authorizing the user to access the enclosed space 101.

Authenticating technique 300 using a transducer of the mobile robot 100 can facilitate voice recognition 306. The transducer can be configured to convert sound into an electrical signal. The transducer can be installed to the processing unit of the mobile robot. The server 500 and/or the processing unit can comprise the database storing at least one voice sample from the at least one user. The processing unit can further be configured to identify the speaker by verifying at least one speech of the user. Authenticating technique 300 can also be configured with a piezoelectric or similar knocking sensor. The user terminal may be sent a one time or a long-term knock code and by inputting the knock code (309) the user may be authorised to access the item.

The user can also be authenticated using a near field communication protocol (NFC) (307). The authentication of the user can comprise using a contactless smart card. The authenticating sensor may further be configured with an NFC chip for example. And the authenticating sensor may only provide an access to the user when a specific credit card, smart card is used.

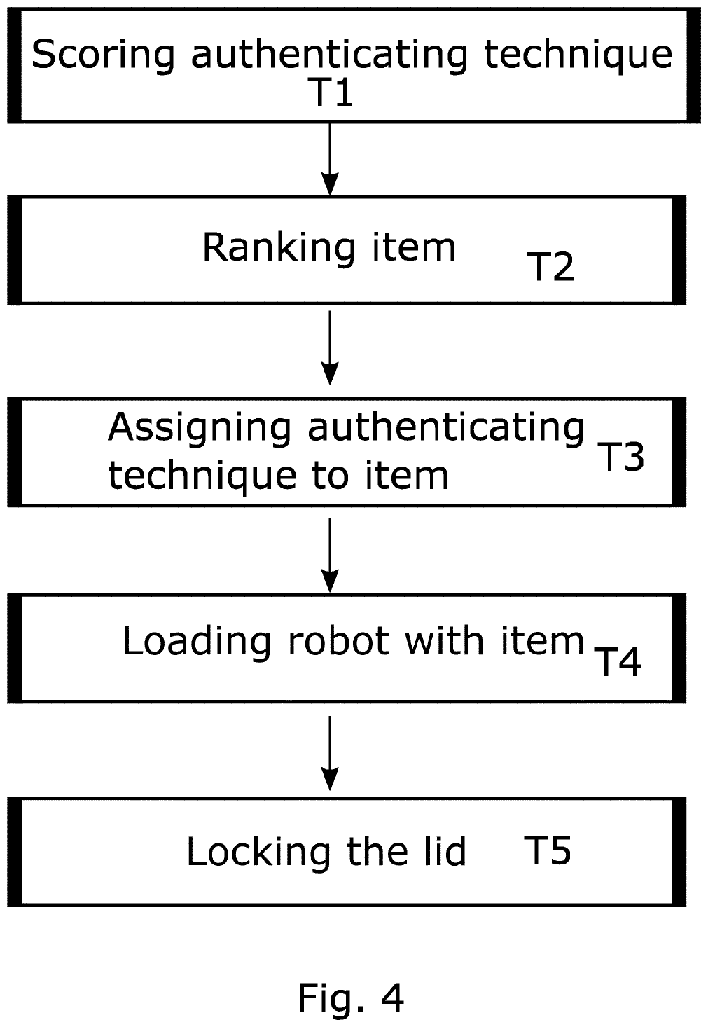

FIG. 4 schematically lists the steps of a method for operating a mobile robot according to an aspect of the present invention. More particularly, FIG. 4 lists the steps of a method for assigning at least one security level to an item at the sender location. The method illustrated in FIG. 4 is particularly advantageous for assigning at least one authenticating technique 300 to at least one item to be transported. T1 can comprise the step of ranking the authenticating technique 300. T2 can comprise ranking the at least one item to be transported. The processing unit can comprise machine-learned ranking of the at least one item. The processing unit can further comprise automated information retrieval of the at least one type of the item. The processing unit can further comprise automatically retrieve information and rank the item. Ranking the item T2 can comprise assigning a security score and a convenience score to the item. In some embodiments the sender or the receiver can choose the level of security. The processing unit can be trained on the at least one type of the item to choose the level of security. The ranking of an authenticating technique T1 can comprise the server 500 generating a technique security score associated with each authenticating technique 300. The server 500 can also be configured to generate a technique convenience score associated with each authenticating technique 300. Further the server 500 can comprise associating the at least one authenticating technique 300 with the item. The association is such way that the security and the convenience is optimised.

The server 500 can be configured to create at least one first group of the authenticating technique with security score value lying within a pre-determined range. For example, the security score can be a value between 0 and 1 so all the authenticating techniques 300 with security score between 0-0.5 can be configured to participate in the first group. The server 500 can further comprise classifying the authenticating techniques 300 with a convenience score value between a pre-determined range in at least one second group. The server 500 can further be configured to assign the at least one of authenticating techniques from the at least one of the first group and the second group to the item. For example, a sender is sending important documents with an item ranking such that the item requires higher security level, the server 500 can be configured to match the item rank to at least one authenticating technique from the first group with a high security score. It can also assign a second authenticating technique from a second group. In some other examples, the server 500 can also assign a plurality of authenticating techniques from a plurality of first groups to match the rank of the item.

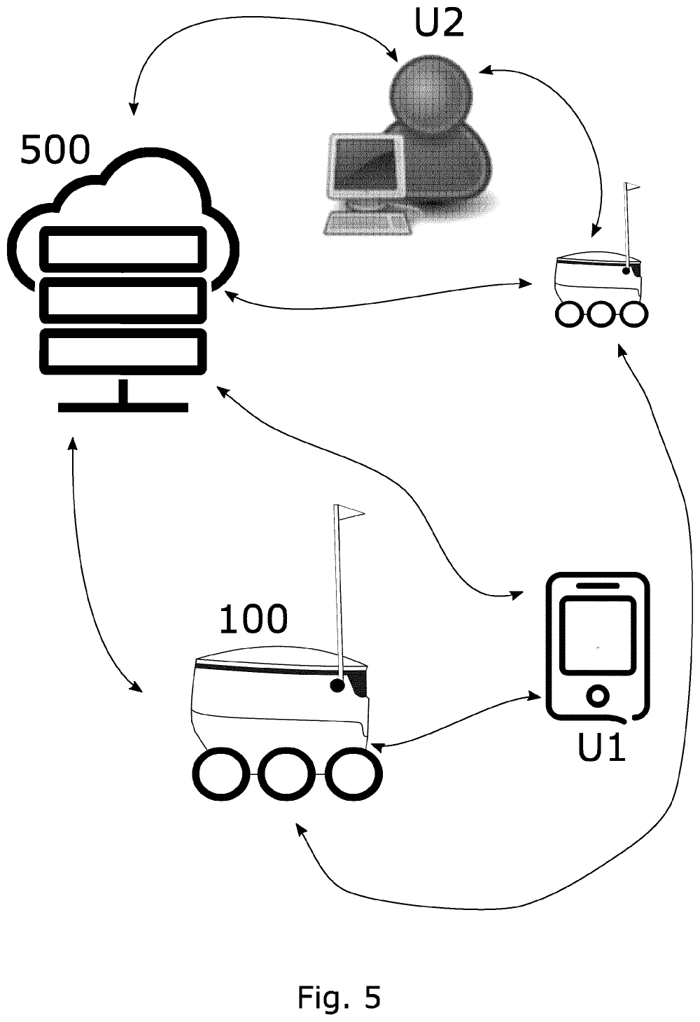

FIG. 5 schematically shows communication within the delivery system including some optional elements of the system. The mobile robot 100 and the at least one user U1 U2 can be configured to communicate via a two-way communication component. Further, the user U1, U2 can be communicating with a second mobile robot. The communication between the mobile robot 100, user U1, U2 and the server 500 can be established via different protocols. There can be different communication protocols for different connections. There can also be more than one protocol for one connection used as a failsafe.

There can be a further communication between the mobile robot 100 and the server 500. The user U1, U2 can be communicating to the mobile robot 100 via the server 500. The U1, U2 can be enquiring the server 500 about the whereabouts of the robot 100. The server 500 can further be communicating to the mobile robot 100 which authenticating technique 300 to use. The robot 100 can be using the communication to notify the user U1, U2 of its location.

Both the user U1, U2 and the robot 100 can be configured to enable a two-way communication with the server 500.

The term “at least one of a first option and a second option” is intended to mean the first option or the second option or the first option and the second option.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

1. A method for secure and convenient delivering of items, the method comprising:
loading an item space of a mobile robot with at least one item to be delivered;
s locking an enclosing structure of the mobile robot so as to prevent access to the item space; and
associating one or more authenticating techniques with at least one of the items to be delivered and the mobile robot.

2. The method according to claim 1 wherein the method comprises the step of generating an identification (ID) associated with the at least one item, wherein the ID comprises at least one of at least one type of the item and parameter of the item and sender data and receiver data and a user preferred security level and a user preferred convenience level.

3. The method according to claim 2 wherein the method further comprises inputting the ID in at least one of at least one processing unit of the mobile robot and at least one server, wherein the at least one or the plurality of authenticating techniques are associated with the item using the ID.

4. The method according to claim 2 wherein the method comprises associating the at least one or a plurality of one or more authenticating techniques with the item based on an automatically generated security score of the item, wherein the security s score is generated based on the ID of the item.

5. The method according to claim 3 wherein the security score is generated by at least one of the server and the processing unit, further, generating at least one technique security score associated with each authenticating technique.

6. The method according to claim 2 wherein the method comprises associating the one or more authenticating techniques with the item based on an automatically generated convenience score of the item, wherein the convenience score is generated based on the ID of the item.

7. The method according to claim 6 wherein the convenience score is generated by at least one of the server and the processing unit, further, generating at least one technique convenience score associated with each authentication technique.

8. The method according to claim 6 wherein the method further comprising the step of grouping the authenticating techniques in at least one first group and/or at least one second group, wherein the technique security score and the technique convenience score is within a pre-determined value respectively.

9. The method according to claim 8 wherein the method comprises associating at least one of the at least one first group and at least one second group to the item to be delivered, further, loading the item space of the mobile robot based on at s least one of the first group and the second group and the authenticating technique.

10. The method according to claim 6 wherein the method comprises generating the technique convenience score based on at least one of a type of communication protocol required to activate an authenticating sensor of the mobile robot and a type of a user input required to activate the authenticating sensor.

11. The method according claim 10 wherein the method further comprises sensing at least one user terminal at a delivery location using the authenticating sensor.

12. The method according to claim 11 wherein the method comprises the further step of automatically activating the authenticating sensor when the mobile robot is within a pre-determined distance of the user terminal.

13. The method according to claim 11 wherein the method further comprises authenticating at least one user at the delivery location to access the item space of the mobile robot once the user is authenticated via the authenticating sensor.

14. The method according to claim 1 wherein the method comprises the step of automatically at least one of unlocking and opening the enclosing structure of the robot to provide access to the item space.

15. A system configured to securely and conveniently deliver item/s to users, the system comprising:
at least one server adapted for receiving, storing, and sending item data;
a mobile robot comprising a processing unit configured to communicate with the server and one or more authenticating sensors, configured to sense at least one user terminal at a delivery location;
the one or more authentication sensor further configured to authenticate the at least one user to access the item space;
wherein the system is further configured to provide access to the item to the user; and wherein the system is furthermore configured to carry out the method according to claim 1.

16. The system according to claim 15 wherein the processing unit is further configured to generate at least one of a security score and a convenience score based on item data.

17. The system according to claim 15 wherein the system further comprises the mobile robot traveling to a delivery location and facilitating the user to access an item space based on the authentication by the authenticating sensor.
